(19) United States
(12) Patent Application Publication
(10) Pub. No.: US 2003/0026396 A1
(43) Pub. Date: Feb. 6, 2003

(54) Method of executing transactions of electronic money amounts between subscriber terminals of a communication network, and communication network, transaction server and program module for it

(75) Inventors: Hartmut Weik, Stuttgart (DE); Wolfgang Lautenschlager, Weissach-Flacht (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/206,947

(22) Filed: Jul. 30, 2002

(30) Foreign Application Priority Data
Aug. 2, 2001 (EP) 01440252.3

(51) Int. Cl. G06F 17/60; H04M 11/00

(52) U.S. Cl. 379/93.12; 705/35

(57) ABSTRACT

The invention concerns a method of executing transactions of electronic money amounts between subscriber terminals of a communication network, with the steps of setting up a communication connection between a paying subscriber terminal which participates in a transaction and a transaction server, setting up a communication connection between a receiving subscriber terminal which participates in a transaction and a transaction server, receiving data to determine the paying subscriber terminal, the receiving subscriber terminal and the money amount to be transferred in the transaction server, and debiting the stated money amount from a money memory of the paying subscriber terminal and crediting this money amount to a money memory of the receiving terminal, with the mediation of the transaction server, and a communication network, a transaction server, and program module for it.

### BACKGROUND OF THE INVENTION

The invention is based on a priority application EP 01 440 252.3 which is hereby incorporated by reference.

The invention concerns a method of executing transactions of electronic money amounts between subscriber terminals of a communication network, and a communication network, a transaction server and a program module to run in a transaction server for it.

For some time, a number of methods which make it possible to transfer money amounts electronically from one Giro account to another Giro account have been known. For this purpose, mostly magnetically stored data of an appropriate bank card of a buyer is read into a seller terminal, and the amount to be transferred is entered into the seller terminal. The seller terminal then contacts a finance server and transfers relevant identification and transaction data. After checking this data, the finance server initiates a debit from the buyer's Giro account and a credit to the seller's Giro account. This or similar methods have a high security standard, because the Giro accounts, the finance server and to some extent also the seller terminal are secure against manipulation. Additionally, all postings are logged, and can therefore be understood. On the other hand these methods have the disadvantage that special seller terminals are necessary. Additionally, time-consuming tests and verifications take place, for instance a test of the buyer's liquidity.

For payment of smaller money amounts, there are so-called money cards, which can be charged up at particular money terminals of banks against a debit from a Giro account. The debit from electronic money of the money card to a central account of the buyer takes place on seller terminals which are provided for the purpose. These money cards have an electronic chip with a microcomputer and a memory which is protected against unauthorized access, and to and from which money amounts can be credited and debited. Communication between the money terminal and money card on the one hand and the seller terminal and money card on the other hand is secure, i.e. security data is added to the useful data, which is encrypted. Additionally, here too logging and in general daily checking of the transaction sums take place.

For payment using a mobile telephone, a method in which electronic accounts are set up on a server for customers of a supplier of an electronic payment service is known. This server can be reached via the mobile communication network. To carry out a money transaction, a paying subscriber makes a call to this server and transmits the mobile call number of the mobile telephone of a receiving subscriber and a money amount. This money amount is debited from the paying subscriber's account and credited to the receiving subscriber's account. The receiving subscriber's mobile telephone then receives a message from the server, for instance in the form of a so-called short message of the mobile communication short message service.

Patent application WO99/00773, entitled “Transaction method carried out with mobile apparatus”, describes a method by which electronic money amounts can be transferred from a money memory card of a mobile telephone to an account of a seller. For this purpose, a protected computer of the money memory card reduces the stored money amount by a specified transaction amount, produces a digital transaction voucher which is secure against manipulation, and attaches a digital signature to the transaction voucher. This signed transaction voucher is then transmitted to the seller terminal. The seller terminal checks the signature, attaches another digital signature and transmits this data to a finance server, which checks the signatures and the transaction voucher. The finance server then initiates a credit of the money amount to an account of the seller. For security against manipulation, a debit can be carried out from a customer test account.

The above-mentioned patent application also describes a method by which the above-mentioned money memory card of the mobile telephone can be charged up via the mobile communication network.

All the listed methods have in common that for a transaction of a money amount from one subscriber to another subscriber, accounts which are administered centrally or on the network side are required. This means high communication and administration costs.

### SUMMARY OF THE INVENTION

The invention is based on the object of creating a convenient, transparent method for subscribers of a communication network and the means which are required to execute it. These means make it possible to transfer money amounts directly from one subscriber to another subscriber.

The basic idea of the invention, similarly to transactions in coins and notes in traditional payment methods, is to take electronic money amounts from an electronic purse of one customer or paying subscriber of a communication network and put them into a purse of a seller or receiving subscriber. As the electronic purse, a money memory of a paying and a receiving subscriber terminal of a communication network respectively are used. For this purpose, a communication connection between a paying subscriber terminal and a receiving subscriber is set up using a transaction server. Via these communication connections, the transaction server receives data to determine the identity of the subscribers who are participating in a transaction, and data which makes it possible to determine a unique electronic money amount to be transferred and a unique payment relation, i.e. exactly one paying subscriber terminal and one receiving subscriber terminal. Then, with the mediation of the transaction server, the stated money amount is debited from the money memory of the paying subscriber terminal and this money amount is credited to the money memory of the receiving terminal.

Other advantageous features of the invention can be taken from the dependent claims and the description.

### BRIEF DESCRIPTION OF THE DRAWINGS

Below, the invention is explained in more detail with the aid of the drawing:

FIG. 1 shows schematically a communication network according to the invention, to carry out the method according to the invention.

FIG. 1 shows a mobile communication network CN, which as an example has a first mobile switching center (MSC) EX1 and a second mobile switching center EX2, and also a transaction server FS. A first (mobile communication) terminal MS1 is connected as an example to the first mobile switching center EX1 via a radio interface and a base station center (BSC), which is not shown here. A second terminal MS2 is connected as an example to the second mobile switching center EX2. The transaction server FS is connected to both the first mobile switching center EX1 and the second mobile switching center EX2. As an example, for the first terminal a display D1, a first (intelligent) memory card SC1 and a keyboard KB are shown. The first memory card SC1 contains a microcomputer, which is not shown here, and a first memory M1. Similarly, the second terminal MS2 has a second memory card SC2 with a corresponding memory M2.

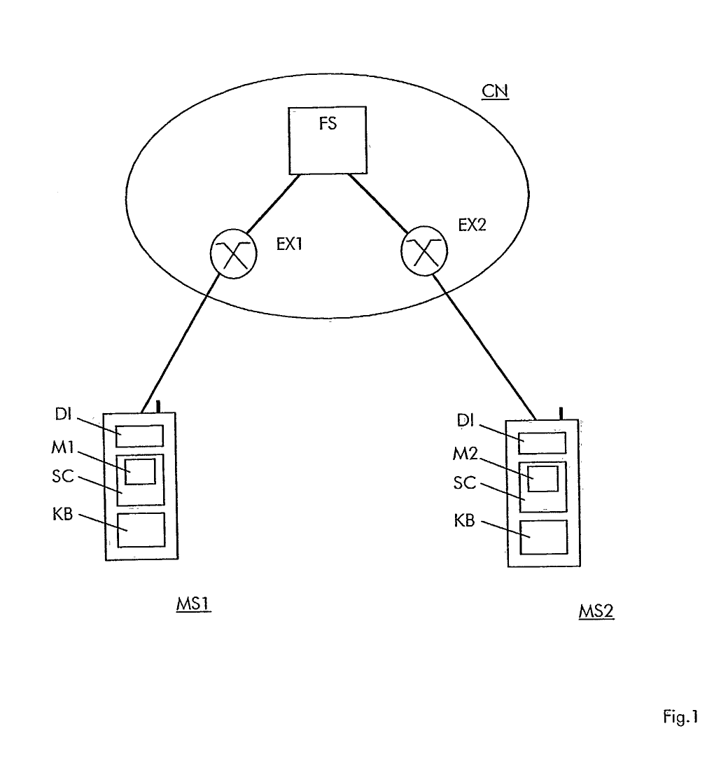

The transaction server FS can terminate several communication connections simultaneously. Here it represents a third entity, which is secured against possible manipulation of the subscribers who are participating in transactions.

As an example, the mobile communication network CN represents a digital communication network according to the widely distributed GSM (Global System for Mobile communication) standard. In such a communication network, the identity of each terminal (frequently also called authenticity testing of the corresponding subscriber) is tested before a call is set up. This is done using cryptographic methods, in collaboration between the terminal and other network components. For this purpose, each terminal is provided with a so-called SIM (Subscriber Identification Module) card, usually in plug-in form. The SIM card has a microcomputer with a (small) operating system and a memory, in which a secret digital key which cannot be read out is held. Only an authentication center of the mobile communication network CN has a copy of this key. Using this key, and a random number which is newly generated by the authentication center for each call, a current key for encryption of the useful data is calculated in the terminal. This SIM card can additionally be used as a money memory card SC1 or SC2. Alternatively, the money memory card SC1 or SC2 is implemented as a separate, additional card which can be plugged into a mobile terminal or connected to it.

The transaction server FS can consist of a central computer with hardware and software, or linked computers, or multiple decentralized computers which communicate with each other. In particular, various tasks, for instance control of services, data management, subscriber communication, generation of secured transaction data and optional encryption, decryption, signature or signature checking can each be assigned to physically distinct computers.

Below, an embodiment of a method according to the invention will be described on the basis of a functional communication flow between the devices which participate in a money transaction. To simplify the language, both a person who participates and the subscriber terminal which this person uses are simply called “subscriber”.

A first subscriber MS1 dials a call number of the transaction server FS,

the first mobile switching center EX1 sets up a communication connection between the first subscriber MS1 and the transaction server FS,

the transaction server FS receives from the first mobile switching center EX1 data to identify the first subscriber MS1, and from the first subscriber MS1, to authorize the transaction, a password or identification number (this test can be omitted if the security requirements are not high; in this case, the identification test of the mobile communication network as described above is enough),

the first subscriber MS1 transmits the call number or a unique name of a second subscriber MS2 and a money amount to be transferred from his or her terminal to this terminal,

after a positive password test, the transaction server FS initiates the setup of a communication connection via the second mobile switching center EX2 to the second subscriber MS2,

the transaction server FS receives, optionally after an authorization test which takes place similarly to the above-mentioned authorization test for this subscriber, the desired money amount from the second subscriber MS2; alternatively, the transaction server FS transmits the money amount given by the first subscriber and requests a confirmation message,

the transaction server FS tests the money amount transmitted by the first subscriber MS1 and the money amount transmitted by the second subscriber MS2 for identity; alternatively, it tests the confirmation message of the second subscriber MS2,

in the case of identity (or reception of a valid confirmation message), the transaction server FS debits the stated money amount from the money memory Ml of the paying first subscriber MS and credits this money amount to the money memory M2 of the receiving second subscriber MS2, and

at least the first subscriber receives an electronic receipt which is signed by the transaction server FS, giving the recipient, amount and time of the transaction.

In an advantageous version, all essential data which is exchanged between the subscribers and the transaction server is signed to ensure its integrity and authenticity. The signature can be carried out using known methods, for instance an asymmetrical encryption method.

Electronic money can be transferred in various ways. A possible simple method is that the transaction server FS, before debiting the money memory M1 of the first subscriber MS1, first receives a record which is electronically signed by the first subscriber MS1 and which gives the current balance of the first subscriber's account. This record also includes a transaction counter, which is increased after each transaction and stored (held) in the transaction server FS, and a signature of the transaction server FS, which prevents unnoticed manipulation of this data. The transaction server first checks the signature of the first subscriber MS1 to ensure the integrity of the above-mentioned record (e.g. test whether the record which the first subscriber MS1 transmitted was received without falsification). Then the record itself is tested, first the signature of the transaction server (i.e. test whether the data of the first subscriber MS1 has been changed), and then the transaction counter (test whether the current record was transmitted). There is a further test for whether the account balance is enough to be able to debit the desired amount (question about the credit line). If all tests are completed positively, the money amount is debited by the transaction server FS transmitting a new record with a new account balance, which has been reduced by the debited amount compared to the old account balance, and a transaction counter with the value of an increased counter value compared to the old transaction counter, to the first subscriber MS1. The second money memory M2 of the second subscriber MS2 is then credited or charged up by a similar method.

Alternatively, it is possible to carry out the transaction using known methods for charging up and debiting so-called money cards or smart cards. In the above-mentioned patent application WO99/00773, detailed embodiments for both charging up and debiting a SIM card are described.

It is also possible to carry out the transaction by passing on digital money units directly from one subscriber to the other. Each of these money records includes a digital serial number, and is signed with security data to prevent falsification. The subscribers can test this signature independently (alternatively, the transaction server FS can carry out this test). The transaction server FS monitors that this record is transmitted only once from one paying subscriber, until it becomes the recipient of this record again. If the test result is positive, the transaction server passes on the relevant money record unchanged to the receiving subscriber.

In a further alternative, both subscribers MS1 and MS2 call the transaction server FS and each transmit a money amount, the fact that they are the transmitter and receiver respectively of this money amount, and the call number of the receiver or transmitter respectively. The transaction server FS tests all this information for identity, and if the result is positive, carries out the other steps of the transaction.

Communication from the subscribers MS1 and MS2 to the transaction server FS can be by speech communication and/or keyboard input into the keyboard KB of subscribers MS1 and MS2. For speech recognition, the transaction server FS carries out a so-called speech-to-text conversion, which translates the received speech information into digital information. Conversely, the information to be transmitted by the transaction server FS to subscribers MS1 and MS2 is converted into speech by a so-called text-to-speech conversion, and transmitted to these subscribers.

To increase security, it can be provided that a subscriber MS1 or MS2 which is ready for a transaction opens its money memory M1 or M2 respectively only for a specified time period. A receiving subscriber therefore rejects incoming money data after this period, and transmits an appropriate message to the transaction server FS. The transaction server can also test for conformity to this period.

If the subscribers MS1 and MS2 keep electronic money accounts in different currencies, the transaction server FS can automatically carry out a currency conversion. Advantageously, it informs both subscribers about the amounts of both currencies. It can also carry out an intermediate step, in which it requests a confirmation message or acceptance message from both subscribers or from the subscriber which must confirm a money amount which has been requested by the other subscriber.

In an advantageous variant, the mobile communication network CN represents a mobile communication network with WAP capability. For this purpose, at least the first subscriber MS1 has a so-called micro browser, which enables him or her to call up so-called WAP pages from a corresponding WAP server using the so-called Wireless Application Protocol (WAP). The transaction server FS is used as the WAP server or is connected to a WAP server. Similarly to the versions described above, a line-connected communication connection is set up between the subscriber MS1 and the transaction server FS (or the WAP server which is connected to the transaction server), and data traffic flows across it as described below. Subscriber MS1 requests a particular WAP page using the browser. This WAP page includes input fields, into which the subscriber MS1 enters, for instance, his or her password, the money amount and the call number or WAP address of the second subscriber. This information is transmitted to the transaction server FS (when a Return key is pressed or a particular screen button (OK button) is selected). Further communication between the transaction server FS and the first subscriber MS1 takes place similarly. Communication between the transaction server FS and the second subscriber MS2 can be carried out either conventionally or also using WAP pages. The advantage of WAP communication is that all data which is relevant to the subscriber can simply be displayed on the display Dl of the terminals.

The method according to the invention is independent of the physical characteristics or communication protocols of the communication network CN. The method according to the invention can above all be applied advantageously in future mobile communication networks according to the so-called UMTS standard (UMTS=Universal Mobile Telecommunications System).

The method as it stands can also be carried out in the public fixed network or the Internet. The terminals of this network have either a plug-in position for a SIM card or smart card or an interface to which a separate read-write device for such cards can be connected. Additionally, these terminals have special communication software so that they can communicate with the SIM card.

The security requirements for an implementation of the method according to the invention in the Internet are higher than with implementation of the method in a line-connected network. The danger of eavesdropping attacks in the Internet is significantly higher than in line-connected networks, in particular higher than in the described GSM network, in which, as described, the identity of the subscriber is always tested and all useful data is encrypted to be transmitted. The danger of data manipulation, i.e. changing, suppression or multiple transmission by unauthorized third parties is thus significantly higher in the Internet. However, these problems can be solved using known powerful encryption methods and signature methods.

1. Method of executing transactions of electronic money amounts between subscriber terminals of a communication network, with the following steps:
setting up a communication connection between a paying subscriber terminal which participates in a transaction and a transaction server,
setting up a communication connection between a receiving subscriber terminal which participates in a transaction and a transaction server,
receiving data to determine the paying subscriber terminal, the receiving subscriber terminal and the money amount to be transferred in the transaction server, and
debiting the stated money amount from a money memory of the paying subscriber terminal and crediting this money amount to a money memory of the receiving terminal, with the mediation of the transaction server.

2. Method according to claim 1, wherein firstly the paying subscriber terminal initiates the setting up of a communication connection to the transaction server, and transmits the call number of the receiving subscriber, and then the transaction server initiates the setting up of a communication connection to the receiving subscriber.

3. Method according to claim 1, wherein the transaction server, after the transaction has taken place, transmits a transaction voucher to the paying subscriber terminal.

4. Method according to claim 3, wherein this transaction voucher has a digital signature of the transaction server.

5. Method according to claim 1, wherein in addition to the identification of the paying subscriber terminal, data to authenticate the corresponding subscriber, particularly a password, is transmitted to the transaction server.

6. Method according to claim 1, wherein the transaction amount is established by each of the subscriber terminals transmitting the amount to be paid or the amount to be received respectively to the transaction server, and the transaction server, before the transaction, testing whether the stated amounts are identical.

7. Method according to claim 1, wherein the transaction amount is established by one of the subscriber terminals transmitting the amount to be transferred to the transaction server, the transaction server informing the other subscriber terminal about this amount, and the other subscriber terminal transmitting a confirmation of it to the transaction server.

8. Method according to claim 1, wherein the subscriber terminals represent terminals of a mobile communication network with WAP capability, and communication between the transaction server and the subscriber terminals takes place using WAP pages.

9. Method according to claim 1, wherein a subscriber MS1 or MS2 which is ready for the transaction opens its money memory M1 or M2 respectively only for a specified time period.

10. Communication network with a transaction server to mediate a transaction of electronic money amounts between subscriber terminals, comprising the following means:
means of setting up a communication connection between a paying subscriber terminal and the transaction server on the one hand, and a communication connection between a receiving subscriber terminal and the transaction server on the other hand,
means of receiving data to determine the paying and receiving subscriber terminals, receiving data to determine a transaction amount, and receiving electronic money,
means of transmitting the received electronic money onward.

11. Transaction server to mediate a transaction of electronic money amounts between subscriber terminals, comprising the following means:
interface to set up a communication connection to a paying subscriber terminal and a communication connection to a receiving subscriber terminal,
means of receiving data to determine the paying and receiving subscriber terminals, receiving data to determine a transaction amount, and receiving electronic money,
means of transmitting the received electronic money onward.

12. Program module to run in a service computer to mediate a transaction of electronic money amounts and to control the following steps:
setting up a communication connection to a paying subscriber terminal,
setting up a communication connection to a receiving subscriber terminal,
receiving data to determine the paying subscriber terminal, the receiving subscriber terminal and the money amount to be transferred by the transaction server, and
debiting the stated money amount from a money memory of the paying subscriber terminal and crediting this money amount to a money memory of the receiving terminal, with the mediation of the transaction server.
